(19) United States
(12) Patent Application Publication
(10) Pub. No.: US 2026/0160099 A1
(43) Pub. Date: Jun. 11, 2026

(54) DEVICE FOR SECURING DOOR LOCK AND HANDLES

(71) Applicant: SnatchLatch, LLC, Flower Mound, TX (US)

(72) Inventors: Timothy Boykin, Plano, TX (US); Jesus Martinez, Garland, TX (US)

(21) Appl. No.: 19/193,567

(22) Filed: Apr. 29, 2025

Related U.S. Application Data
(60) Provisional application No. 63/729,501, filed on Dec. 9, 2024.
(60) Provisional application No. 63/739,463, filed on Dec. 27, 2024.

(51) Int. Cl. E05B 83/02

(52) U.S. Cl. CPC E05B 83/02

(57) ABSTRACT

A device for securing a door lock and handle is disclosed. The device comprises a housing having a front wall and side walls. At least one of the side walls defines a slot for receiving the door lock and handle and at least partially enclose the door lock and handle. The device further comprises a locking portion for receiving a lock therewithin. The device further comprises a sliding plate for selectively enclosing the door lock and handle. The sliding plate is configured to be engaged with the lock and be locked thereby when the lock is received within the locking portion.

### FIELD OF THE DISCLOSURE

The present disclosure generally relates to locking devices, and more particularly to a device for securing a door lock and handles, for instance of rolling up the door of a box truck or trailer of a semi-truck, to prevent unauthorized operation of the door lock and handles.

### BACKGROUND

In the realm of cargo transportation, trailers and trucks often rely on cam bar locks or similar mechanisms to secure their rear and side doors. The existing mechanism typically include a handle that is to be actuated (rotated or pivoted) to lock and unlock the door. While effective in basic operation, the existing mechanisms are vulnerable to various security threats, particularly due to easy accessibility of the handle. In existing mechanisms, the handle and/or lock (or other actuation components) are exposed and can be easily tampered with. Thieves can easily disengage the locks and manipulate the handle. The lack of protection for the handle/lock and associated components is a significant weakness.

In some scenarios, an additional locking arrangement, such as a padlock, is used in conjunction with the handle. However, such an arrangement is still exposed and can be tampered with by thieves. For instance, thieves can easily access the additional locking arrangement for tampering, rendering the additional locking arrangement ineffective for securing the doors of trailers and trucks. The cargo transported in trailers and trucks is often valuable, making these vehicles prime targets for theft. The security provided by existing mechanisms is insufficient to secure the doors of the trailers and trucks from theft, leading to significant financial losses and operational disruptions.

### SUMMARY

Disclosed herein is a device for securing a door lock and handle.

The device can include a housing having a front wall and sidewalls. At least one of the side walls can define a slot configured to receive the door lock and handle and at least partially enclose the door lock and handle. The device can include a locking portion extending outwardly from the housing. The locking portion can be configured to receive a lock therewithin. The device can include a sliding plate configured to selectively cover or engage the door lock and handle. The sliding plate can be movable between a pulled position exposing the door lock and handle, and a pushed position. The sliding plate can be configured to be engaged with the lock and be locked thereby when the lock is received within the locking portion, so as to restrict the movement of the sliding plate towards the pulled position.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1A illustrates an isometric view of a door lock and handle;

FIG. 1B illustrates a side isometric view of a device for securing a door lock and handle according to the disclosure;

FIG. 1C illustrates another side isometric view of the device of FIG. 1B;

FIG. 2A illustrates a bottom isometric view of the device of FIG. 1A;

FIG. 2B illustrates a close-up side view of a slot formed in the device according to the disclosure;

FIG. 3A illustrates an isometric view of the device of FIG. 1A, with a locking portion free of engagement with a lock according to the disclosure;

FIG. 3B illustrates an isometric view of the device of FIG. 3A, with a lock being received within the locking portion according to the disclosure;

FIG. 3C illustrates a front isometric view of the lock according to the disclosure;

FIG. 3D illustrates a rear isometric view of the lock of FIG. 3C;

FIG. 3E illustrates the lock received within the locking portion, with a key tumbler in an exterior position according to the disclosure, upside down with respect to the positions of the lock in FIGS. 3C and 3D, with its keyhole accessible from below;

FIG. 3F illustrates an isometric view of the device of FIG. 3B, with the cap in the covering position thereof according to the disclosure;

FIG. 3G illustrates an isometric view of the cap of FIG. 3F according to the disclosure;

FIG. 3H illustrates another isometric view of the device with the cap in the covering position thereof;

FIG. 4A illustrates the device of FIG. 3A, with a sliding plate in a pulled position thereof according to the disclosure;

FIG. 4B illustrates a close-up keyhole view of the open end of the locking portion of the device, with the sliding plate in a pushed position thereof according to the disclosure;

FIG. 4C illustrates a bottom isometric view of the device of FIG. 4A, with the sliding plate in the pulled position thereof according to the disclosure;

FIG. 4D illustrates a bottom isometric view of the device of FIG. 4C viewing up, with the sliding plate in the pushed position thereof according to the disclosure;

FIG. 4E illustrates a side close-up view of a portion of the device of FIG. 4C, showing the opening for the locking bar, in the unlocked condition;

FIG. 4F depicts a side close-up view of a portion of the device of FIG. 4D, showing the opening for the locking bar, in the locked condition

FIG. 5 illustrates an overall external isometric view of the top, front, and left sides of the housing and the external end of the sliding plate, when pushed in to the locked condition, and the housing tab of an embodiment the locking device;

FIG. 6 illustrates an overall external isometric view of the top, front, and left sides of the housing and the external end of the sliding plate, when pulled out to the unlocked condition, of an embodiment the locking device;

FIG. 7 illustrates an overall isometric wire frame view of the top, front, and left sides of the housing and the external end of the sliding plate, when pushed in to the locked condition, and the housing tab of an embodiment the locking device, with the internal parts inside the housing shown in dotted lines;

FIG. 8 illustrates an overall isometric wire frame view of the top, front, and left sides of the housing and the external end of the sliding plate, when pulled out to the unlocked condition, along with the housing tab of an embodiment the locking device, with the internal parts inside the housing shown in dotted lines;

FIGS. 9A-F illustrate an overall isometric view of the set of individual parts of the locking device, including the slider (9A), case (9B), rivets (9C), puck lock (9D); internal crossbar (FIG. 9E); and puck lock cover (9F);

FIG. 10 A1 through 10A4 illustrate the order of assembly of the slider depicted in FIG. 9A-9F, depicting, in order, the steps of inserting the slider into case, including preparing to insert the slider into the case (FIG. 10A1) and then putting the slider into the open bottom (FIG. 10A2); and then snaking the slider into its final position (FIG. 10A3 through FIG. 10A4), shown in cut-away with the right side wall of the case removed;

FIG. 10 B1 through B4 illustrate the order of assembly of the crossbar depicted in FIG. 9E, depicting, in order, the steps of inserting crossbar into case, beginning with preparing to insert crossbar into case (FIG. 10B1) and then putting the crossbar into the open bottom (FIG. 10B2), and the snaking the crossbar into its final position (FIG. 10B3 through FIG. 10B4), shown in cut-away with the right side wall of the case removed;

FIG. 10C shows the installation of the rivets into the sides of the case, to hold the crossbar in place, which completes the physical assembly of the device, prior to installation of the device onto the trailer door handle.

FIGS. 11A-11C illustrate an overall isometric view of the assembled device being installed onto a trailer door handle (FIG. 11A); then installing and engaging the puck lock (FIG. 11B); and then pushing the puck lock cover onto the puck lock, by which step the installation is complete FIG. 11C);

FIG. 12 illustrates an exploded overall isometric view of the top, front, and left sides of a modified housing and modified sliding plate assembly for another embodiment of the locking device, with the cap in place;

FIG. 13 illustrates a cutaway side view through the centerline of the modified housing of the embodiment the locking device illustrated in FIG. 12, with the cap installed;

FIG. 14 illustrates an overall isometric view of the top, front, and left sides of the modified housing of the embodiment the locking device illustrated in FIGS. 1B and 1C, with the cap installed;

FIG. 15 illustrates an exterior isometric view of the front, and left sides of the housing of the modified embodiment the locking device illustrated in FIG. 12, without the cap installed

FIG. 16A illustrates a top view of the sliding plate for the locking device depicted in FIGS. 1B and 1C;

FIG. 16B illustrates isometric view of the sliding plate for the locking device depicted in FIGS. 1b and 1c;

FIG. 17 illustrates an exploded overall external isometric view of the top, front, and left sides of the modified housing, of the embodiment the locking device illustrated in FIG. 12, including the puck lock, and cap.

FIG. 18 illustrates an overall external isometric view of the top, front, and left sides of the modified housing of the embodiment the locking device illustrated in FIG. 12, including the modified sliding plate, puck lock, and cap;

FIG. 19 illustrates an exploded isometric view of the top, front, and left sides of the modified housing, and the modified sliding plate assembly when removed from the front opening of the embodiment the locking device illustrated in FIG. 12, the puck lock, and cap with internal parts shown in dotted lines;

FIG. 19 illustrates an exploded overall isometric wire frame view of the top, front, and left sides of the housing, and the modified sliding plate assembly when removed from the front opening of the embodiment the locking device illustrated in FIG. 12, with the puck lock, and cap; with internal parts shown in dotted lines

FIG. 20 illustrates an exploded isometric view of the top, front, and left sides of the modified housing, and the modified sliding plate assembly when removed from the front opening of the embodiment the locking device illustrated in FIG. 12;

FIG. 21 illustrates an overall isometric wire frame view of the top, front, and left sides of the modified housing, and the modified sliding plate assembly when removed from the front opening of the embodiment the locking device illustrated in FIG. 12, without the puck lock and cap;

FIG. 22 illustrates an exploded isometric wireframe view of the top, back and left side of the housing of the embodiment the locking device illustrated in FIG. 12;

FIG. 23 illustrates overall external assembled embodiment the locking device illustrated in FIG. 12, with the cap installed;

FIG. 24 illustrates another wireframe view of the assembled embodiment the locking device illustrated in FIG. 12, with internal parts shown in light lines;

FIG. 25 illustrates another wireframe view of the assembled embodiment the locking device illustrated in FIG. 12, with internal parts shown dotted lines; and

FIG. 26 illustrates another view of the housing of the locking device illustrated in FIGS. 1A and 1B, shown in isometric view from its top, front, and right side, showing in the locked condition with the plate assembly pushed in.

### DETAILED DESCRIPTION

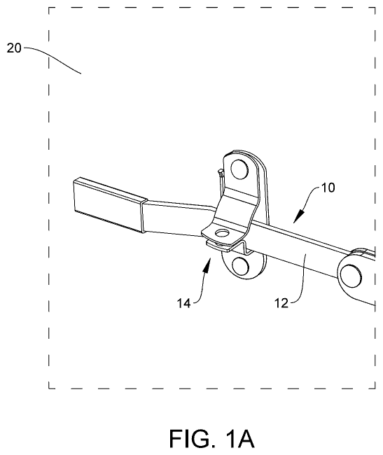

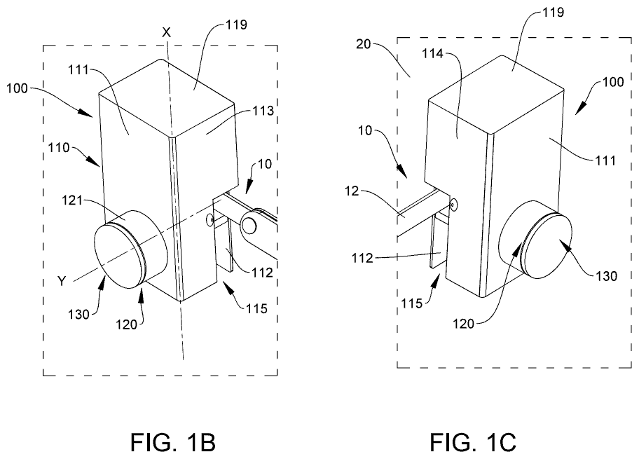

“Door lock and handle” as used herein refers to an arrangement to lock and unlock a door. For instance, the door lock and handle may be installed in connection with a door of a trailer, a wagon, a caravan, and other transport vehicles. For purposes of description herein, the terms “upper”, “lower”, “upright”, “vertical”, “horizontal”, and derivatives thereof shall relate to the device as oriented in FIG. 1B.

Various embodiments of a device for securing the door lock and handle are disclosed. The device is generally configured to engage with the door lock and handle and restrict movement of the door lock and handle.

FIG. 1A illustrates a door lock and handle 10. The door lock and handle 10 may be coupled to a door 20 of a trailer (not shown). The present invention relates to a device for securing the door lock and handle 10, and consequently, the door of the trailer. The device as described herein secures the door lock and handle 10 and prevents opening of the door of the trailer 20. For instance, the device as described herein restricts operation of the door lock and handle 10 so as to open the door of the trailer 20 unless the lock is unlocked by an authorized person.

In an embodiment, the door lock and handle 10 may be a cam bar lock. The door lock and handle 10 may comprise a cam bar 12 and a cam keeper 14. The cam bar 12 may be a handle pivotally attached to the door of the trailer with hinges or brackets. The cam keeper 14 may be configured to engage with the cam bar 12 in a closed position of the door lock and handle 10, i.e., when the door of the trailer is closed. When closing the door, the cam bar 12 may be pivoted to bring the cam bar 12 into engagement with the cam keeper 14. The cam keeper 14 receives the cam bar 12 and retains the cam bar 12 such that the door remains in the closed position. When the door is to be opened, the cam bar 12 is pivoted out of engagement with the cam keeper 14 so as to enable opening of the door.

It is appreciated that although the door lock and handle 10 is depicted as a cam bar lock, the door lock and handle 10 may be any other type of door lock and handle that can be secured by the device as described herein without departing from the scope of the invention.

Reference is now made to FIGS. 1B and 1C which illustrate isometric views of a device 100 for securing a door lock and handle, such as the door lock and handle 10. The device 100 may be configured for securing the door lock and handle 10 when the door lock and handle 10 is in the closed position thereof, i.e., when the door of the trailer 20 is closed. The device 100 may be configured to restrict the movement of the door lock and handle 10 such that the door lock and handle 10 remain in the closed position thereof. For instance, the device 100 may be configured to restrict the pivoting movement of the cam bar 12 of the door lock and handle 10 to prevent the cam bar 12 from pivoting out of engagement with the cam keeper 14 for opening of the door of the trailer 20.

In an embodiment, the device 100 may be locked in a locked state in which the device 100 restricts the movement of the door lock and handle 10 and prevents opening of the door of the trailer 20. The device 100 may be shifted to an unlocked state which allows free movement of the door lock and handle 10 and in which the device 100 can be removed.

The device 100 may comprise a housing 110 extending along a generally upright longitudinal axis X. In an embodiment, the housing 110 may be a hollow housing defining a space therewithin. The space within the housing 110 may enable movement of one or more components of the device within the housing 110, as will be described further below. In an embodiment, the housing 110 may be formed of a hardened steel or other high-strength materials to resist drilling, cutting, and other forms of tampering.

The housing 110 may comprise a front wall 111 and an opposite back wall 112. The back wall 112 may be more proximal to the door 20 of the trailer than the front wall 111, when the device 100 is engaged with the door lock and handle 10 to secure the door lock and handle 10. In an embodiment, the front wall 111 and the back wall 112 may extend parallel to each other. That is, a portion of the back wall 112 will be slid down into the space between the handle 10 and the face of door 20 when housing 110 is installed.

The housing 110 may further comprise side walls 113, 114. The side walls may include a first side wall 113 and a second side wall 114. The first side wall 113 and the second side wall 114 may extend between the front wall 111 and the back wall 112. The first side wall 113 and the second side wall 114, together with the front wall 111 and the back wall 112, define the housing 110. In an embodiment, the first side wall 113 and the second side wall 114 may extend parallel to each other.

The housing 110 may further comprise a top wall 119.

In an embodiment, when the device 100 is in engagement with the door lock and handle 10, the housing 110 of the device 100 may be configured to rest over and cover the door lock and handle 10, with the back wall 112 slid down into the space between the handle 10 and the face of door 20. The door lock and handle 10 may be spaced from the door of the trailer 20 so as to allow at least some portion of the housing 110, such as back wall fingers 112, to be received within the space, i.e., between the door lock and handle 10 and the door of the trailer 20.

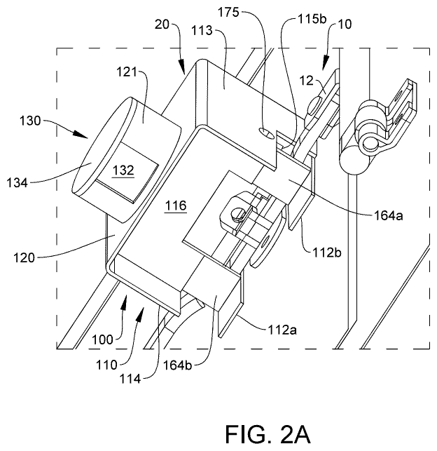

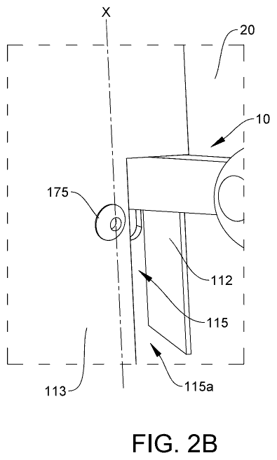

The housing 110 may further comprise slot 115 in the rear portion of the sides 113 and 114, respectively, from one side through the other, to form a side-to-side space open at the bottom and configured to receive the door lock and handle 10 from the bottom. In that way, the slot 115 may enable the housing 110 to come into engagement with the door lock and handle 10. For instance, the slot 115 may allow the housing 110 to rest over, cover, or engage the door lock and handle 10 such that the back wall is disposed in the space between the door lock and handle 10 and the door of the trailer 20. In an embodiment, as depicted in FIG. 2A, the back wall 112 may be prong shaped with fingers 112a and 112b, so as to be disposed in the space between the door lock and handle 10 and the door of the trailer 20 without being hindered by the cam keeper 14.

Referring to FIGS. 2A-2B, the slot 115 of the housing 110 is described. FIG. 2A illustrates a bottom view of the device 100 in engagement with the door lock and handle 10 locked, by means of legs 164 of sliding plate shown in the locked condition, to be described in more detail subsequently. FIG. 2B illustrates a close-up side view of the slot 115 from one side thereof.

The slot 115 may be through the first side wall 113, the second side wall 114, and a portion of back wall 112 with its fingers 112a and 112b capable of being slid down in between the handle 10 and door 20. In an embodiment, the slot 115 may be defined by the first side wall 113 and the back wall 112. In an embodiment, the slot 115 may be defined by the second side wall 114 and the back wall 112. The slot 115 may be a cutout or recess within the housing 110. The slot 115 may be bordered by the first side wall 113, the second side wall 114, and the back wall 112, so as to define a three-dimensional open area. The slot 115 may be configured to receive the door lock and handle 10 in the three-dimensional area defined by the first side wall 113, the second side wall 114, and the back wall 112.

When the locking devise is in the unlocked condition, slot 115 can allow the door lock and handle 10 to be received into the slot 115. In an embodiment, the slot 115 may be configured to allow the door lock and handle to be received in a direction along the longitudinal axis X. The open end of slot 115, when the device is in the unlocked state, and may be dimensioned to freely receive the door lock and handle 10. When the slot 115 receives the door lock and handle 10, the housing 110 can come into engagement with the door lock and handle 10. Further, when the device 100 is in engagement with the door lock and handle 10, the housing 110 of the device 100 may be configured to rest over and cover the door lock and handle 10. In particular, when the slot 115 receives the door lock and handle 10, the back wall 112 of the housing 110 may be disposed within the space between the door lock and handle 10 and the door of the trailer 20.

In an embodiment, in the unlocked state, the open end of slot 115 further be configured to allow the door lock and handle 10 to be removed from the slot 115. For instance, during a process of disengagement of the device 100 from the door lock and handle 10, in its unlocked state, the door lock and handle 10 may be displaced generally upwardly relative to the device 100 such that the door lock and handle 10 can be withdrawn from the slot 115 via the open end of the slot 115.

In an embodiment, the slot 115 may be configured to at least partially enclose and cover the door lock and handle. For instance, the slot 115 may be configured to enclose the door lock and handle so as to restrict the movement of the door lock and handle 10, in particular, the pivoting of the cam bar 12, in one or more directions, as will be described further below.

The slot 115 may be bounded at one side by a partial bottom end wall 116 configured cover the front portion of the opening. The partial bottom end wall 116 may act as a delimiting portion for the movement of the door lock and handle 10 relative to the slot 115, when the door lock and handle 10 are being received within the slot 115. In an embodiment, the partial bottom end wall 116 may form a part of at least one of, or both of, the first side wall 113 and the second side wall 114, or may be secured thereto, such as by welding. In an embodiment, the partial bottom end wall 116 may be defined by one or more portions of the first side wall 113 and the second side wall 114 that coincide with the boundaries of the slot 115. The partial bottom end wall 116 may provide a bottom support for a sliding plate assembly 160, to be described subsequently, and, together, when the sliding plate is pushed in, engage the door lock and handle to prevent removal of the locking device.

In the present disclosure, the terms ‘upper’ and ‘lower’ may be understood with reference to the ground, in that, the upper side may refer to the side farther from the ground than the lower side.

Referring again to FIGS. 1B-1C, the device 100 may comprise a locking portion 120. The locking portion 120 may facilitate fixing of the device 100 with respect to the door lock and handle 10 such that the device 100 locks in engagement with the door lock and handle 10. In an embodiment, the locking portion 120 may be formed of a similar material as the housing 110. In an embodiment, the locking portion 120 may be formed of hardened steel or other high-strength materials to resist drilling, cutting, and other forms of tampering.

The locking portion 120 may extend outwardly from the front wall 111 of the housing 110. In an embodiment, the locking portion 120 may extend in a direction transverse to the longitudinal axis X. As depicted, the locking portion 120 may extend along a transverse axis Y which is transverse to the longitudinal axis X. In an embodiment, the locking portion 120 may be integrally formed with the front wall 111 of the housing 110. In an embodiment, the locking portion 120 may be separately formed from the housing 110 and fixedly coupled to the front wall 111 during manufacturing of the device 100. In an embodiment, the locking portion 120 may be formed together with the housing 110 such that the locking portion 120 forms a part of the housing 110.

In an embodiment, the locking portion 120 may comprise a wall 121 defining the locking portion 120. In an embodiment, the locking portion 120 may be a tubular member and the wall 121 may be a tubular wall 121. It is appreciated that the locking portion 120 may be of any other configuration instead a tubular member, without departing from the scope of the invention. For instance, as a non-limiting example, the locking portion 120 may be a cubical member having a cubical wall. The locking portion 120 may be configured to receive a lock therewithin, and the locking portion 120 may enable access to a sliding plate to facilitate locking of the device 100 with respect to the door lock and handle 10, as will be described in detail further below.

The device 100 may comprise a cap 130 configured to engage with the locking portion 120. The cap 130 acts as a cover to prevent access to one or more portions of the locking portion 120, to components of the device 100 through the locking portion 120, and to one or more external elements disposed within the locking portion 120. In FIGS. 1B-1C, the cap 130 is in a covering position thereof in which the cap 130 is in engagement with the locking portion 120. The cap 130 may be disposed to an uncovering position in which the cap 130 is withdrawn from engagement with the locking portion 120.

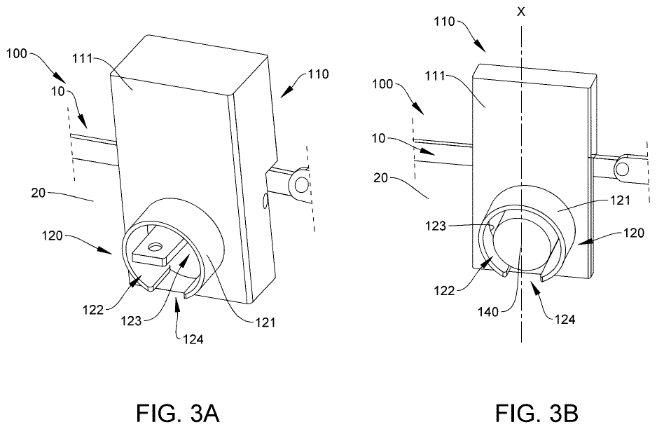

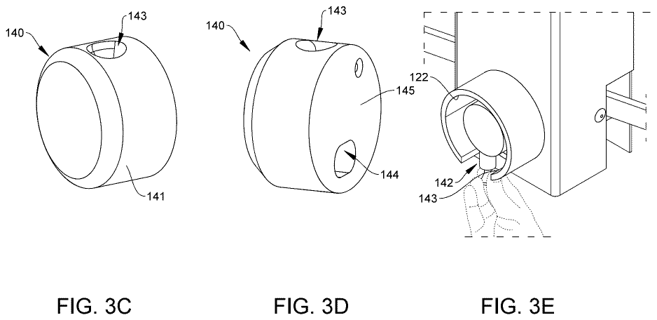

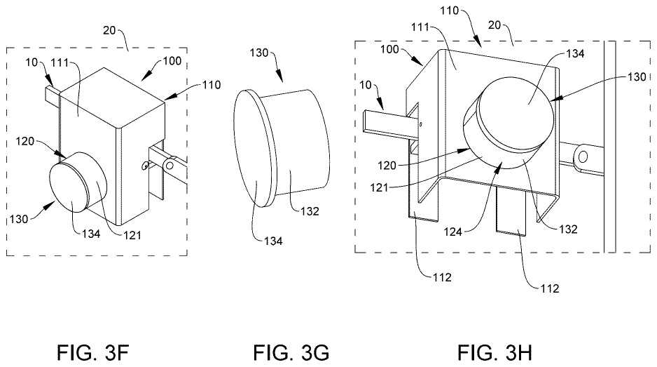

Referring to FIGS. 3A-3H, the locking portion 120 and the cap 130 will be described. FIG. 3A illustrates an isometric view of the device 100, with the locking portion 120 free of engagement with the cap 130. FIG. 3B illustrates an isometric view of the device 100 with a lock 140 being received in the locking portion 120.

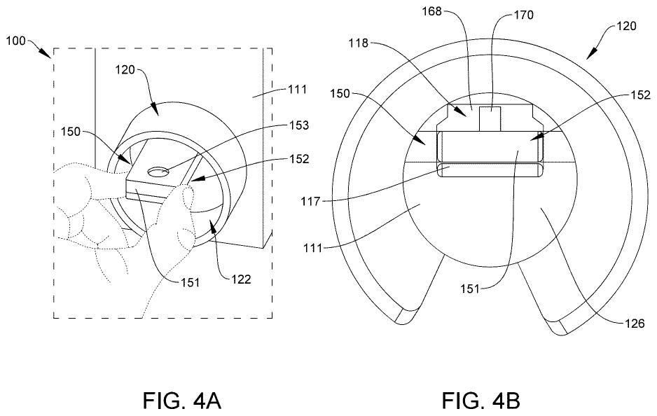

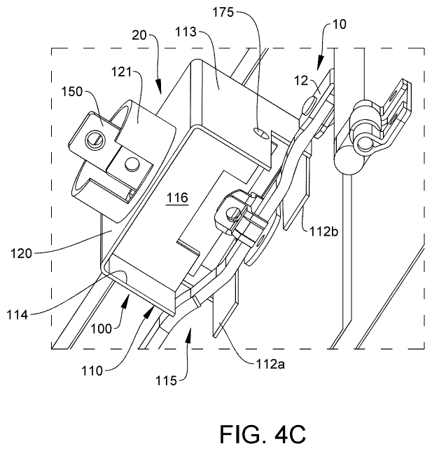

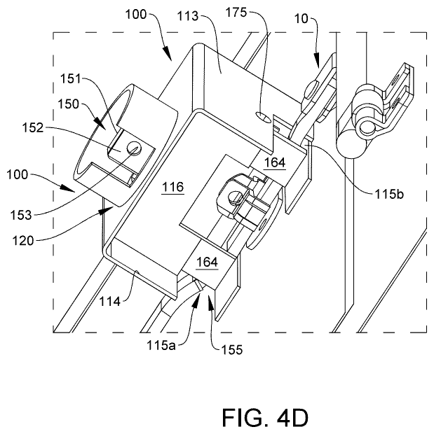

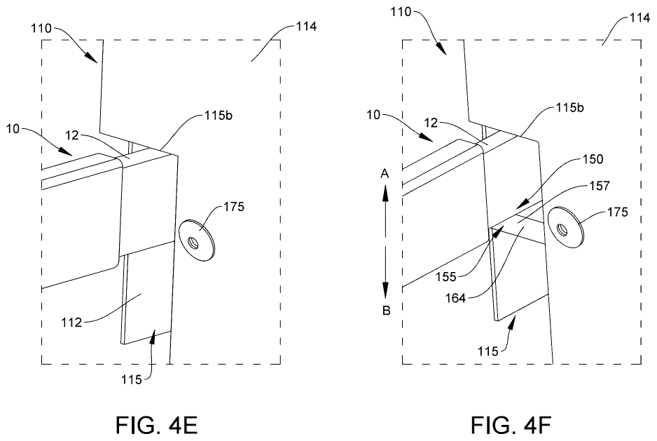

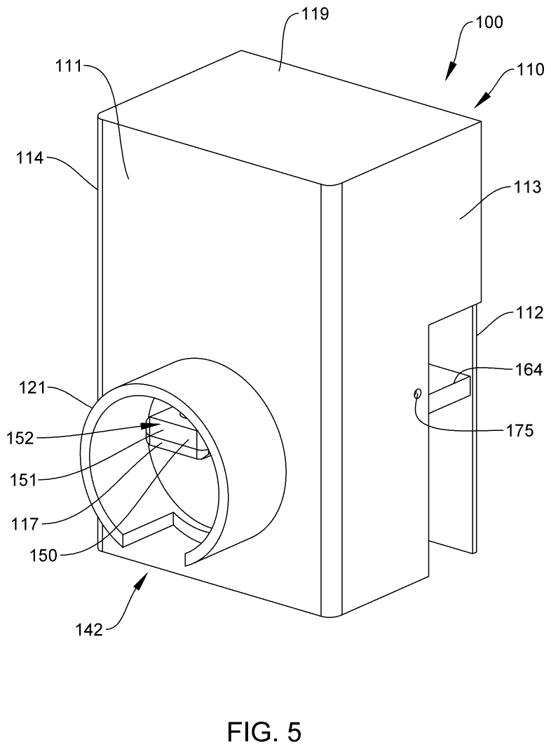

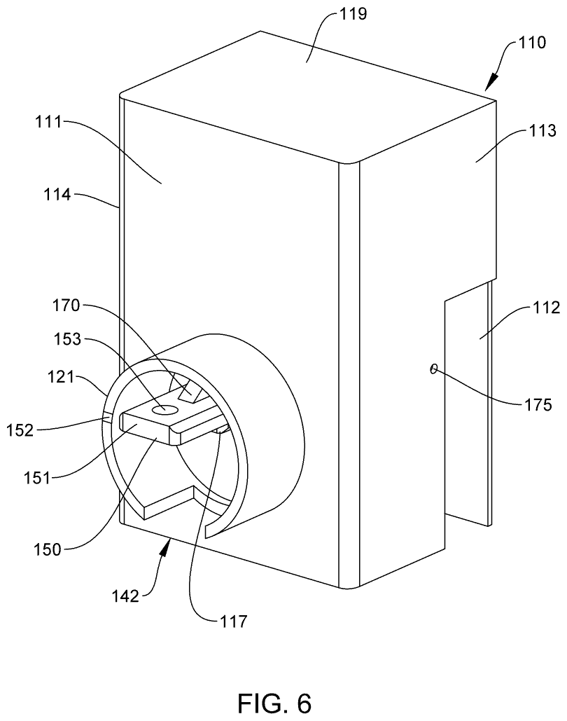

The locking portion 120 may comprise a lock receiving opening 122 for receiving the lock 140 within the locking portion 120 via the lock receiving opening 122. The wall 121 of the locking portion 120 may extend from the front wall 111 of the housing 110 until the lock receiving opening 122. The wall 121 may define a lock space 123 within the locking portion 120. The lock 140 may be received within the lock space 123 via the lock receiving opening 122. The lock space 123 may be configured to accommodate the lock 140 therein. The lock space 123 may further be configured to accommodate at least some portions of a sliding plate and a housing tab (for instance, as described with reference to FIGS. 4A-4B further below).

As seen in FIG. 3B, the lock 140 is disposed within the lock space 123 of the locking portion 120. The lock receiving opening 122 may allow access to the lock space 123, and the lock 140 when the lock 140 is disposed within the lock space 123. The lock receiving opening 122 may allow access in a direction transverse to the longitudinal axis X, for instance, in the direction along the transverse axis Y. In an embodiment, the locking portion 120 may be dimensioned so as to freely receive the lock 140 therewithin. In an embodiment where the locking portion 120 is a tubular member, the diameter of the locking portion 120 may be greater than a diameter of the lock 140.

FIGS. 3C-3E depict the lock 140. FIG. 3C depicts a front isometric view of the lock 140. FIG. 3D depicts a rear isometric view of the lock 140. In an embodiment, the lock 140 may be a puck lock. The lock 140 may comprise a body 141 and a key tumbler 142 with a keyhole 143 that receives a key for locking and unlocking the lock 140. FIG. 3E depicts the lock 140 received within the locking portion 120, with the key tumbler 142 in an exterior position. The key tumbler 142 is movable within the body 141 of the lock 140. The key tumbler 142 is movable between an exterior position (as seen in FIG. 3E) in which the key tumbler 142 and the keyhole 143 extend outwardly from the body 141 of the lock 140, and an interior position (as seen in FIG. 3B) in which the key tumbler 142 and the keyhole 143 are disposed within the boundaries of body 141 of the lock 140. The key tumbler 142 is coupled to a locking pin (not visible) such that movement of the key tumbler 142 causes corresponding movement of the locking pin. In an embodiment, the locking pin may be a cylindrical rod. The lock 140 may include a groove 144 in a back portion 145 thereof, the back portion 145 being a portion which faces the housing 110 in FIG. 3B. The groove 144 may be disposed such that the groove 144 is free of the locking pin when the key tumbler 142 is in the exterior position and the locking pin may pass through the groove 144 along a locking pin path when the key tumbler 142 is in the interior position. In the interior position of the key tumbler 142, the locking pin may engage with the device 100 so as to lock the device 100. In the exterior position of the key tumbler 142, the locking pin may disengage from the device 100 so as to unlock the device 100. The device 100 may thus be disposed between a locked state and an unlocked state using the lock 140.

The locking portion 120 may comprise a gap 124 configured to allow access to the lock space 123, and to the lock 140 when the lock 140 is received within the locking portion 120. The gap 124 may be formed so as to allow access through the locking portion 120 in a direction along the longitudinal axis X. In an embodiment, the gap 124 may be formed in the wall 121 of the locking portion 120. The gap may define an access passage along the longitudinal axis X through the wall 121, the access passage enabling access to the lock 140 when the lock 140 is received within the locking portion 120. For instance, the access passage may enable access to the key tumbler 142 and the key hole 143 of the lock 140 so as to enable locking and unlocking of the lock 140, and consequently, locking and unlocking of the device 100 with the lock 140. In an embodiment, the gap 124 may be formed as a cut-out in the wall 121 of the locking portion 120. In an embodiment where the locking portion is a tubular member, the gap 124 may be formed in the tubular wall of the locking portion 120.

As depicted in FIGS. 3F-3H, the cap 130 may be configured to prevent access to the lock space 123, and with the lock 140 received within the lock space 123. FIG. 3F illustrates an isometric view of the device 100 with the cap 130 in the covering position, i.e., in engagement with the locking portion 120. FIG. 3G illustrates an isometric view of the cap 130. FIG. 3H illustrates another isometric view of the device 100 with the cap 130 in the covering position. In FIGS. 3F and 3H, the cap 130 is depicted in the covering position thereof. The cap 130 may be disposed between the covering position in which the cap 130 prevents access to the lock space 123 and the uncovering position in which the cap 130 is not in engagement with the locking portion 120, for instance as depicted in FIGS. 3A and 3B. In an embodiment, in the covering position of the cap 130, the cap may be configured to be locked in place (in the covering position thereof) covering a majority of the lock 140 to prevent access to the lock 140. In one aspect, the term ‘majority’ as used herein may refer to covering more than 50% of the lock 140. In other aspects, the term ‘majority’ as used herein may refer to covering more than 60%; more than 70%; more than 80%, more than 90%, or more than 95% of the lock 140.

In the uncovering position of the cap 130, the lock 140 may be accessible through the lock receiving opening 122 along a direction transverse to the longitudinal axis X. For instance, the lock 140 may be accessible along the transverse axis Y through the lock receiving opening 122. Further, in the uncovering position of the cap 130, the lock 140 may be accessible through the gap 124. In the illustrated embodiment, the gap 124 is formed so as to allow access to the lock 140 along a direction of the longitudinal axis X. In other embodiments, the gap 124 may be formed on a different portion of the wall 121 so as to allow access to the lock 140 along a different direction.

In the covering position of the cap 130, the cap 130 may be configured to be at least partially received within the locking portion 120. In the covering position, the cap 130 may be configured to cover at least the gap 124 of the locking portion 120 so as to prevent access to the lock 140 when the lock 140 is received within the locking portion 120.

The cap 130 may comprise a first covering member 132 and a second covering member 134. In the covering position of the cap 130, the first covering member 132 of the cap 130 may be received within the locking portion 120, for instance, within the lock space 123 of the locking portion 120. As depicted in FIG. 3H, the first covering member 132 may be configured to cover the gap 124 of the locking portion 120. In the covering position of the cap 130, the second covering member 134 of the cap 130 may be configured to cover the lock receiving opening 122. For instance, the second covering member 134 may align with the lock receiving opening 122 in the covering position of the cap 130. In an embodiment, the dimensions of the second covering member 134 may be substantially similar to the dimensions of the lock receiving opening 122 so as to cover the lock receiving opening 122.

In an embodiment, when the lock 140 is received within the locking portion 120 and the cap 130 is in the covering position, the lock 140 is completely enclosed. The lock 140 is enclosed by the wall 121 of the locking portion and the cap 130, which covers the gap 124 and the lock receiving opening 122 of the locking portion 120. This way, access to the lock 140 is completely covered. In an embodiment, the cap 130 may be formed of a similar material and/or provide a similar visual appearance as the locking portion 120 and/or the housing 110. This way, when the cap 130 is in the covering position, the cap 130 may be visually seen as a part of the housing 110 and/or the locking portion 120, and not as a separate, removable component.

In an embodiment, when the lock 140 is received within the locking portion 120 and the cap 130 is in the covering position, the lock 140 is substantially fully enclosed with the exception of sufficient access to the lock 140 to insert a key in the keyhole of the lock 140. For instance, the cap 130 may include a hole corresponding to dimensions of a key of the lock 140 so as to enable insertion of the key to access the lock 140.

As described above, the lock 140 may engage with the device 100 to be locked with the device 100 and the lock 140 may disengage with the device 100 to be unlocked from device 100. The device 100 may further be locked and unlocked with respect to the door lock and handle 10. When the device 100 is locked with respect to the door lock and handle 10, the device 100 is in a locked state. In the locked state, the device 100 restricts movement of the door lock and handle 10 and prevents the door lock and handle 10 from being actuated for opening the door of the trailer 20. When the device 100 is unlocked with respect to the door lock and handle 10, the device 100 is in the unlocked state. In the unlocked state, the device 100 may be withdrawn from engagement with the door lock and handle 10 so as to enable free actuation of the door lock and handle 10.

As depicted in, for example, FIGS. 4A, 4B, The device 100 may comprise a sliding plate assembly 160 configured to facilitate the device 100 to switch between the locked and unlocked states. The sliding plate assembly 160 may selectively enclose the door lock and handle 10, and further, may engage and disengage with the lock 140, such that the sliding plate assembly 160 enables locking and unlocking of the device 100 with respect to the door lock and handle 10.

Referring to FIGS. 4A-4B, the sliding plate assembly 160 of the device 100 is described. The sliding plate assembly 160 may be configured to selectively cover or engage the door lock and handle 10. The sliding plate assembly 160 may extend in a direction transverse to the longitudinal axis X. The sliding plate assembly 160 may be accommodated at least partially within the housing 110. The sliding plate assembly 160 may be movable in the direction transverse to the longitudinal axis between a pushed position and a pulled position. In the pulled position, the door lock and handle may be exposed. In the pushed position, the door lock and handle may be engaged and enclosed. FIG. 4A depicts the sliding plate assembly 160 in the pulled position thereof. In an embodiment, the sliding plate assembly 160 may displace towards the lock receiving opening 122 when moving to the retracted position from the pushed position. FIG. 4B depicts the sliding plate assembly 160 in the pushed position thereof. In an embodiment, the sliding plate assembly 160 may displace towards the back wall 112 of the housing 110 when moving to the pushed position from the pulled position, when seen from the lock receiving opening 122.

The terms ‘pulled’ and ‘pushed’ as used herein refer to the pulling of the sliding plate assembly 160 away from the back wall 112 and pushing of the sliding plate assembly 160 towards the back wall 112, respectively. In an embodiment, the sliding plate assembly 160 may extend to a greater extent within the locking portion 120, i.e., to a greater extent towards the lock receiving opening 122 in the pulled position than the pushed position. In an embodiment, the sliding plate assembly 160 may extended at least partially out of the locking portion 120 in the pulled position thereof.

When the lock is received within the locking portion 120, the front end or handle 150 of the sliding plate assembly 160 may be configured to be engaged with the lock 140 and be locked thereby. The locking of the sliding plate assembly 160 with the lock 140 causes locking of the device 100 with the lock 140. In an embodiment, the sliding plate assembly 160 may be locked by the lock 140 when the sliding plate assembly 160 is in the pushed position thereof. The locking of the sliding plate assembly 160 with the lock 140, when the sliding plate assembly 160 is in the pushed position, restricts the movement of the sliding plate assembly 160 towards the pulled position.

In an embodiment,, the front end or handle 150 of the sliding plate assembly 160 may engage with the lock 140 when the sliding plate is in the pulled position thereof. Though the sliding plate assembly 160 is configured to be locked by the lock when the sliding plate assembly 160 is in the pulled position, the movement of the sliding plate is restricted only when the sliding plate assembly 160 is locked at the pushed position by the lock 140.

Viewed from the front, locking end, the sliding plate assembly 160 may have its front end 151 of its handle 150 (visible in FIGS. 4D and 4F). The first end 151 of the handle 150 may be proximal to the lock receiving opening 122. The sliding plate assembly 160 may comprise a plate pull tab 152 disposed at the first end 151. The plate pull tab 152 may be configured to engage with the lock 140. In an embodiment, the plate pull tab 152 may be configured to be received within a groove 144 of the lock 140. As described above, the lock 140 may include a groove 144 in a back portion 145 thereof, the back portion 145 being a portion which faces the sliding plate assembly 160 when the lock 140 is being received within the locking portion 120. The groove 144 of the lock 140 may have an opening facing the sliding plate assembly 160 so as to receive the plate pull tab 152 therewithin.

The plate pull tab 152 may include a plate aperture 153 configured to receive a locking pin of the lock 140. As described above, the locking pin of the lock 140 may pass through the groove 144 along a locking pin path. The plate pull tab 152 may be received within the groove 144 such that the plate aperture 153 aligns with the locking pin path. This way, when the key tumbler 142 of the lock 140 is pushed to the interior position, the locking pin would be displaced to pass through the plate aperture 153. In the interior position of the key tumbler 142, the lock 140 is locked. Consequently, the locking pin passing through the plate aperture 153 holds the plate pull tab 152 in position and locked with the lock 140.

In addition to the plate pull tab 152, the lock 140 may also engage with another component of the device 100 along with the plate pull tab 152. The housing 110 may comprise a housing tab 117 extending along the direction transverse to the longitudinal axis X. In an embodiment, the housing tab 117 may extend from the front wall 111 of the housing 110 into the locking portion 120, and act as a surface upon which plate pull tab 152 can slide. In an embodiment, the locking portion 120 may include a back plate 126 and the housing tab 117 may extend from the back plate 126 into the locking portion 120. In an embodiment, the back plate 126 of the locking portion 120 may coincide with a portion of the front wall 111 of the housing 110.

The front wall 111 (or the back plate 126) may comprise a passage 118 configured to allow movement of the sliding plate assembly 160 between the pushed position and the pulled position thereof. The sliding plate assembly 160 may extend at least partially within the locking portion 120 via the passage 118. In an embodiment, at least the plate pull tab 152 extends at least partially into the locking portion 120 (in the lock space 123).

In an embodiment, the plate pull tab 152 may be aligned with the housing tab 117 when the sliding plate assembly 160 is in the pushed position, as depicted in FIG. 4B. In the pulled position of the sliding plate assembly 160, the plate pull tab 152 may extend into the locking portion 120 towards the lock receiving opening 122 to a greater extent than the housing tab 117, as depicted in FIG. 4A. The housing tab 117 may be configured to be engaged with the lock 140 along with the plate pull tab 152. In an embodiment, the housing tab 117 may be configured to be received within the groove 144 of the lock 140. The housing tab 117 may comprise a housing tab aperture (not visible) configured to receive the locking pin of the lock therethrough. When the plate pull tab 152 may be aligned with the housing tab 117, the plate aperture 153 of the plate pull tab 152 aligns with the housing tab aperture of the housing tab 117. As described above, the movement of the sliding plate assembly 160 is restricted only when the sliding plate assembly 160 is locked at the pushed position by the lock 140. When the lock 140 is received within the locking portion 120, and the key tumbler 142 of the lock 140 is pushed to the interior position, the locking pin would be displaced to pass through the plate aperture 153 as well as the housing tab aperture. The locking pin passing through the plate aperture 153 and the housing tab aperture holds the plate pull tab 152 in the pushed position and locked with respect to the housing tab 117. The movement of the sliding plate assembly 160 from the pushed position towards the pulled position is thereby prevented since the locking pin prevents movement of the sliding plate assembly 160 with respect to the housing tab 117. FIG. 3B depicts the lock 140 received within the locking portion 120 and the key tumbler 142 in the interior position (not extending outwardly from the lock 140). In such a position of the lock 140, the plate pull tab 152 and the housing tab 117 are received within the groove 144 of the lock 140, and the locking pin of the lock 140 passes through the plate aperture 153 and the housing tab aperture. The sliding plate assembly 160 is thus held in the pushed position thereof and movement towards the pulled position is prevented by the lock 140 and the housing tab 117.

In operation, to lock the sliding plate assembly 160 in the pushed position (and consequently lock the device in the locked state with respect to the door lock and handle 10), a user may access the sliding plate assembly 160 via the lock receiving opening 122. For instance, the user may move the sliding plate assembly 160 to the pushed position in case the sliding plate assembly 160 is in the pulled position where the door lock and handle is exposed. The user may position the lock 140 within the locking portion 120. At this stage, the lock 140 must first be unlocked and the key tumbler 142 may be in the exterior position such that the groove 144 is free of the locking pin. The user may then insert the plate pull tab 152 into the groove 144 of the lock 140. The user may then push the key tumbler 142 into the interior position, which causes the locking pin to pass through the plate aperture 153 and the housing tab aperture which is aligned with the plate aperture 153. The user may lock the locking pin in position (for instance, by rotating the key in the keyhole 143), thereby fixing the sliding plate assembly 160 in the pushed position thereof.

In the pushed position of the sliding plate assembly 160, the sliding plate assembly 160 may be configured to at least partially cover, engage, and/or enclose the door lock and handle 10. The sliding plate assembly 160, when in the pushed position, is at least partially covering, engaging, and/or enclosing the door lock and handle 10, at least partially enclosing the door lock and handle 10, which causes the device 100 to restrict the movement of the door lock and handle 10.

The sliding plate assembly 160 may extend between the first end 151 and a second end 155, including legs 164. The second end 155 may be proximal to the back wall 112. The second end 155 may be defined by at least one leg 164 configured to at least partially enclose the door lock and handle 10. In the illustrated embodiment, the second end 155 is defined by two legs 164 with a prong-shaped configuration. In an embodiment, the space between the legs 164 allows the cam keeper 14 to be positioned between the legs 164, as depicted in FIG. 4D. It is appreciated that in other embodiments, the second end 155 may be defined by a single leg 164, or more than two legs 164, without departing from the scope of the invention.

In an embodiment, the sliding plate assembly 160 in the pushed position may be at least partially disposed under the door lock and handle 10. In the pushed position of the sliding plate assembly 160, the legs 164 of the sliding plate assembly 160, may be configured to be disposed under the door lock and handle 10 so as to cover, engage, and/or enclose the door lock and handle from a lower side of the door lock and handle 10. Accordingly, when the sliding plate assembly 160 is in the pushed position, and locked, legs 164 of the sliding plate assembly 160 prevent removal of the locking devise 100 from the handle 10 and prevent unlocking the handle 10. For instance, when the legs 164 of sliding plate assembly 160 are extended, the leg or legs 164 at least partially engages the door lock and handle 10 from the lower side of the door lock and handle 10 to restricts movement of the handle 10.

Accordingly, when the housing 110 at least partially encloses the door lock and handle 10, and when the sliding plate assembly 160 is in the pushed position, the device 100 is in the locked state thereof in which a movement of the device 100 with respect to the door lock and handle 10 is restricted. from both the lower side and the upper side, to prevent operation of the door lock and handle 10. Further, the sliding plate assembly 160 may be locked with the lock 140, as described above with reference with FIGS. 4A-4B above, so as to prevent the movement of the sliding plate assembly 160 towards the pulled position. The device 100 thus restricts movement of the door lock and handle 10, such as pivoting of the door lock and handle 10 to open the door of the trailer. This state is shown in FIG. 4F, where the legs 164 have been pushed in toward the back of locking device 100, to restrict movement of handle 10, so that one of legs 164 is visible from the outside in this view. In this state, when the housing 110 at least partially encloses the door lock and handle.

In order to switch the device 100 from the locked state to the unlocked state, the lock 140 may be disengaged from the sliding plate assembly 160, for instance, by shifting the key tumbler 142 to the exterior position to disengage the locking pin from the plate pull tab 152. The lock 140 may then be withdrawn from the locking portion 120 via the lock receiving opening 122 and the sliding plate assembly 160 may be shifted (for instance, by pulling the sliding plate in a direction transverse to the longitudinal axis X) to the pulled position, such as the position depicted in FIG. 4E, where the legs 164 have been pulled forward toward the front of locking device 100, to allow movement of handle 10 and, therefore, are not visible from the outside in this view. In this state, which the sliding plate assembly 160 in the pulled position, the device may be in the unlocked state thereof. In such a configuration, the door lock and handle is exposed and movement of the device 100 with respect to the door lock and handle 10 is allowed. In particular, in the pulled position of the sliding plate legs 164 of sliding plate assembly 160 are no longer disposed under the door lock and handle and enable the movement of the housing 110 with respect to the door lock and handle 10. Accordingly, in the pulled position of the sliding plate assembly 160, a free movement of the door lock and handle 10 within the slot 115 can be enabled. The housing 110 may be moved out of engagement with the door lock and handle 10, such as by moving the housing 110. The door lock and handle 10 may thus be free from engagement with the housing 110 and can be freely moved for opening the door of the trailer 20.

The device 100 may thus be selectively switched between an unlocked state and a locked state. When it is desired to secure the door lock and handle 10, the device 100 may be engaged with the door lock and handle 10 and switched to the locked state by pushing sliding plate assembly 160 in so that its legs 164 block movement of handle 10 from below. As the device 100 prevents movement of the door lock and handle 10, the door lock and handle 10 is prevented from being actuated to open the door of the trailer 20. For instance, an unauthorized person cannot actuate the door lock and handle 10 in view of the device 100 being in the locked state. When it is desired to open the door of the trailer 20, the device 100 can be switched to the unlocked state and moved out of engagement with the door lock and handle 10. The door lock and handle 10 is thus free to be actuated for opening the door of the trailer 20. Accordingly, the device 100 secures the door lock and handle 10 and prevents unauthorized actuation of the door lock and handle 10. Moreover, when the device 100 is in the locked state, the lock 140 is enclosed by the locking portion 120 and the cap 130 (when in the covering position thereof). Access to the lock 140 is covered by the locking portion 120 and the cap 130, which discourages an authorized person to tamper with the device 100 since any part of the lock, such as the keyhole, is not readily visible to the unauthorized person. For instance, an unauthorized person would likely not think of opening the cap and accessing the lock for tampering because the lock is not visible. The door lock and handle are thus properly secured by the device 100, providing enhanced protection against unauthorized access and tampering.

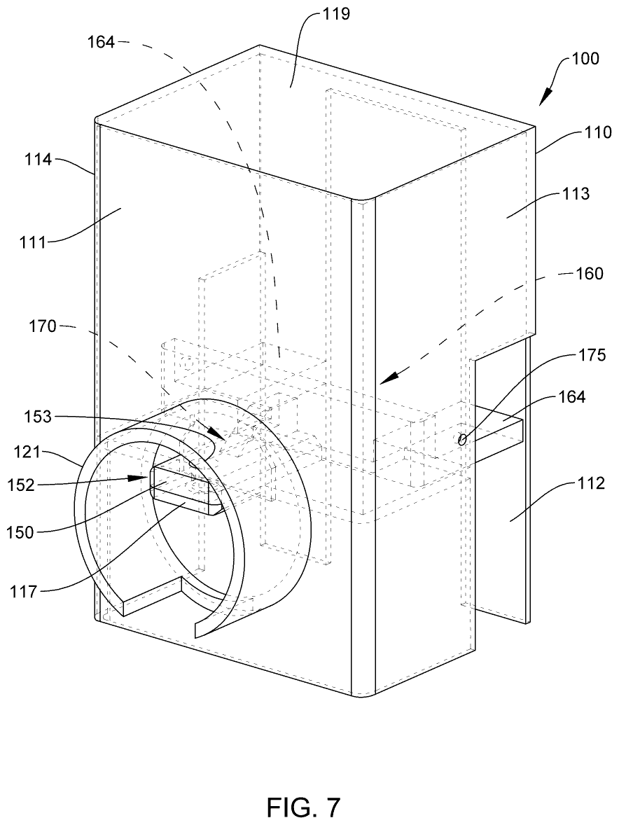

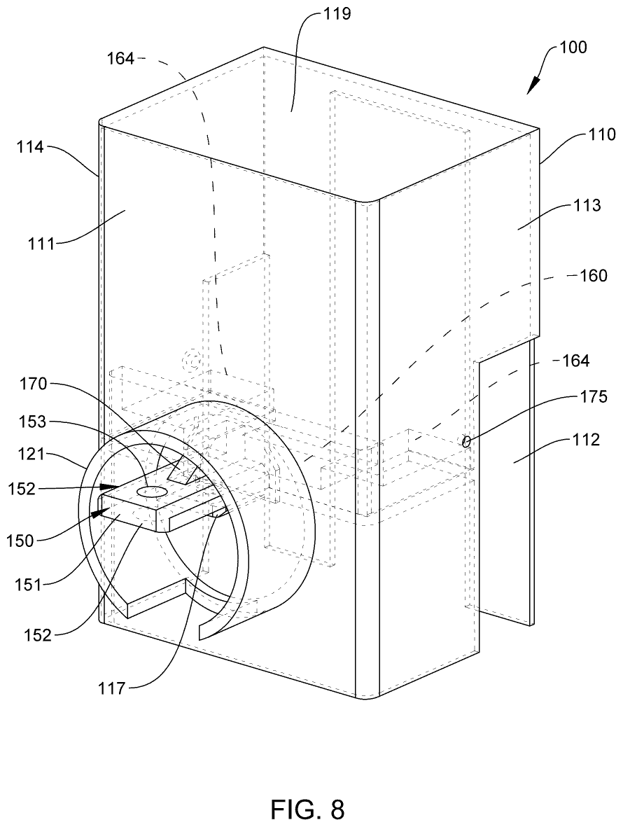

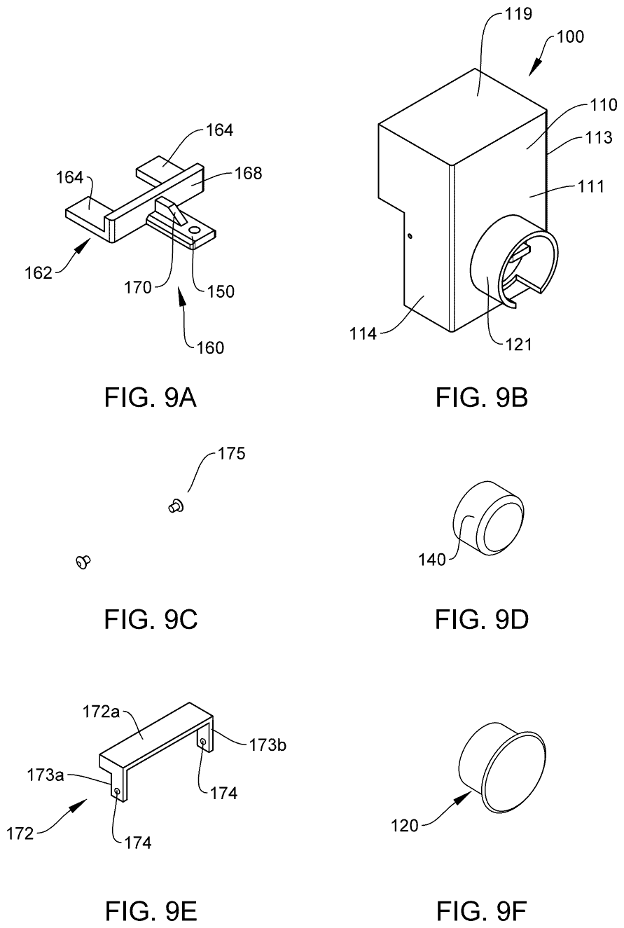

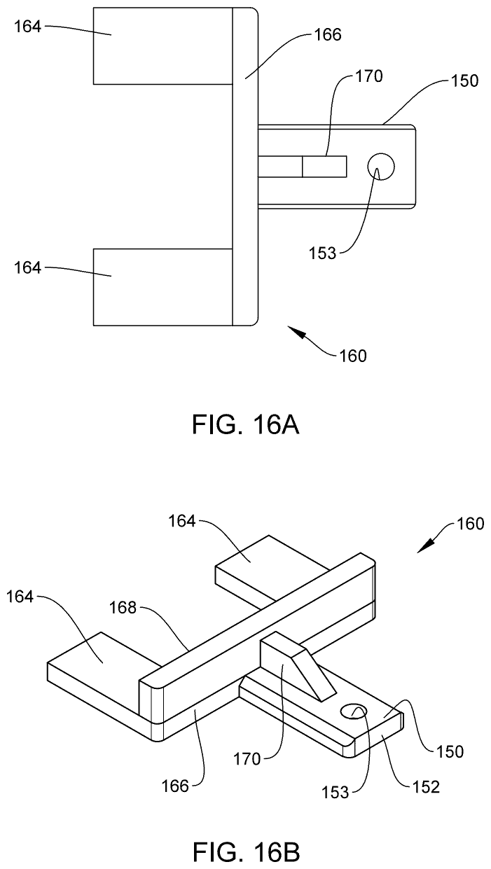

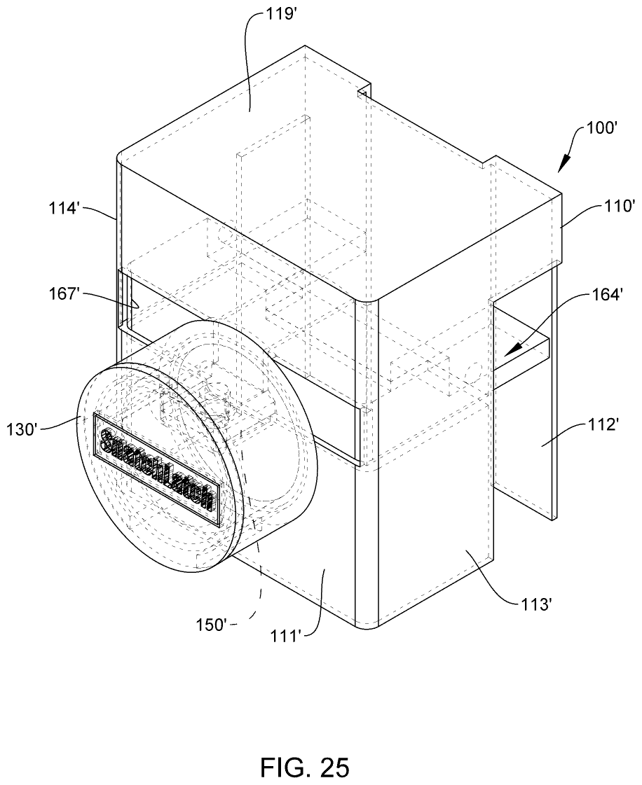

FIGS. 7, 8, 1, 16A, 16B and 25 illustrate an embodiment of a sliding plate assembly 160 (shown inside, in phantom lines), in more detail, including portions normally obscured inside the housing 110 of the device 100. With reference to FIG. 9A, sliding plate assembly 160, shown in isometric view, can be generally in the shape of a yoke or two-pronged fork 162. Fork 162 can have the rearwardly extending legs 164, previously discussed, which are held by cross beam 168, which can be in the same plane as sliding plate assembly 160.

Fork 162 can include a vertical wall 168 along the upper portion of the front of cross beam 168, which can act to impede unauthorized access to inner portions of device 100 on the inside of device, inward of vertical wall 168. Sliding plate assembly 160 can also include a vertical brace 170 interconnecting wall 168 and front slide handle 150, to provide stability to wall 168. These parts of sliding assembly 160 can be welded together, cast, forged or manufactured in any other manner that holds the parts together securely.

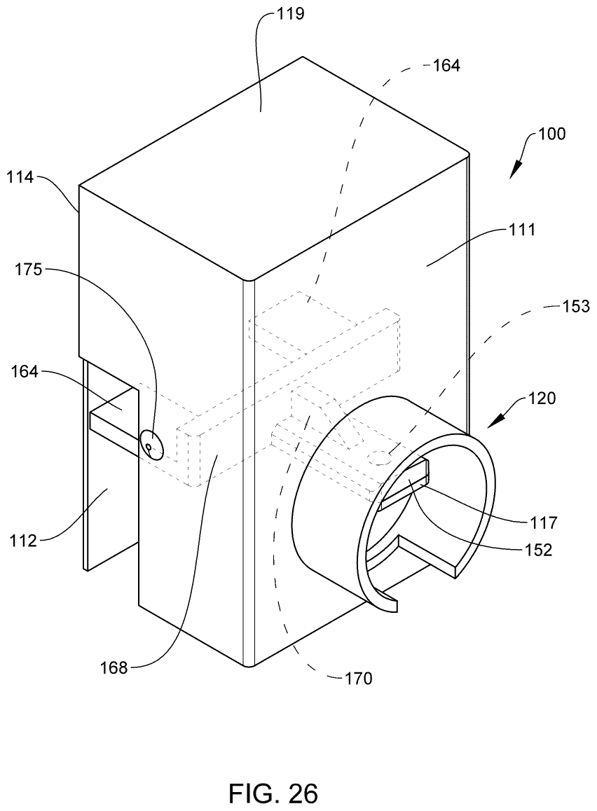

FIG. 26 illustrates a simplified view of locking device 100, with the sliding plate assembly 160 shown inside, in dotted lines, to show the position therefor, in the locked condition, with legs 164 fully extended rearwardly, to secure handle 10 (not show) in place.

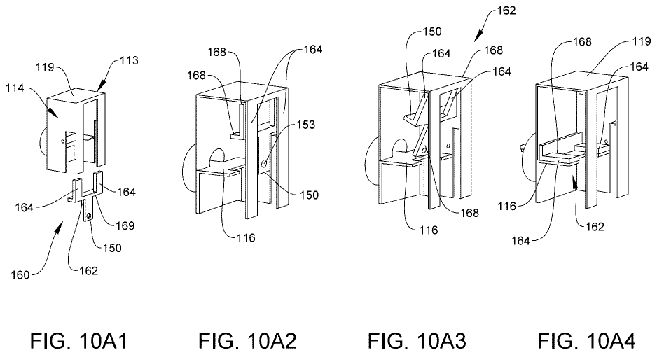

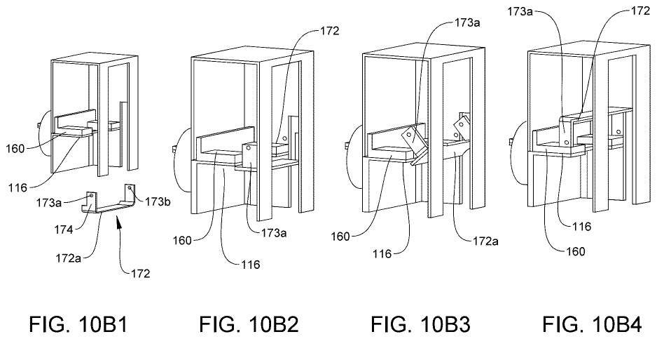

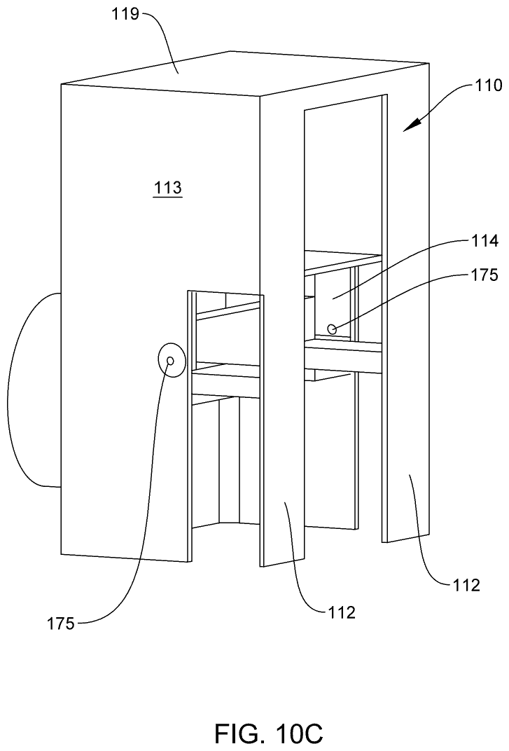

The method of assembly of sliding plate assembly 160 into the locking device 100 is shown sequentially in FIG. 10A1 to 10A4. First, as depicted in FIG. 10A1, sliding plate 160 is positioned with its legs 164 up and pointing into open slot 115. In FIG. 10A2, shown with its left wall remove, sliding assembly 160 would be loosely inserted into the open bottom of the housing 110. Then, in FIG. 10A3, it would be snaked or rotated into position clockwise, with the first end 151 of the handle 150 tipped toward the inside wall of the housing. Then, as shown in FIG. 10A4, the sliding plate assembly 160 is further rotated clockwise until its legs 164 are flat and resting on partial bottom plate 116, which then supports sliding plate assembly 160.

Once the sliding plate assembly 160 is in this position, as depicted in FIG. 10B1, FIG. 10B2, FIG. 10B3 and FIG. 10B4, a crossbar 172, which its wings 173a and 173b at the extreme ends thereof, can be inserted through the bottom opening of the housing and snaked or rotated into position. First, as depicted in FIG. 10B1, cross bar 172 is positioned under open slot 115, with its wings 173a and 173b pointing up into open slot 115. In FIG. 10B2, shown with its left wall removed, cross bar 172 would be loosely inserted into the open bottom of the housing 110. Then, in FIG. 10B2, cross bar 172 is lifted with its middle section 172a flush with the bottom of the legs 164 of sliding plate 160, with its wings 173a and 173b pointing up and wrapping around the legs 164, between legs 164 and the inside wall of side walls 113 and 114. Then, in FIG. 10B3, cross bar 172 would snaked or rotated into position counterclockwise, with the wings 173a and 173b be tipped toward the inside wall of the housing. Then, as shown in FIG. 10A4, the middle section 172a of cross bar 172 is further rotated counterclockwise until its middle section 172a passes up and into the housing 110, continuing counterclockwise rotation until the entire cross bar 172 is positioned 180 degrees from its initial position, with its wings 173a and 173b temporarily supported by legs 164 of sliding plate assembly 162 like legs. In an embodiment, wings 173a and 173 b can have holes 174a and 174b disposed therethrough so as to receive a fastener, which can be a rivet 175.

When the crossbar 172 is in place, and holes 174a and 174b aligned with corresponding holes in sides 113 and 114, rivets 175 can be installed from the outside of the housing 110 to secure the crossbar 172 to the inside of walls 1134 and 114 of the housing 110. Crossbar 172 will thereby capture the sliding assembly 160 within the housing 110 so the sliding assembly 160 cannot fall out of the housing 110 when the housing 110 being handled before and during installation onto the door handle, regardless of the position of the housing 110, but is free to move in and out a limited distance to permit locking and unlocking when the housing 110 and sliding assembly are installed onto the door.

The rivets 175 are not, however, required to prevent unauthorized access to the door handle once the device 100 is fully installed and locked onto the door, which function is accomplished by the lock 140 securing the entire assembly in place on the door. That is, even if the rivets 175 are removed by an unauthorized person when the device 100 is locked onto the door (by drilling the rivets 175 out, for example), the device 100 will remain fully locked in place.

Housing 110 is open at its bottom end and has slots in the lower portion of its side walls 113 and 114 near the rear end of the housing 110 to allow it to be installed onto the door handle. Housing 110 also includes and partial bottom wall 116, as previously discussed, which can be affixed by welding or other secure means to the inside of front wall 111 and the inside portion of side walls 113 and 114 of housing 110, forward of the open slot 115, which acts as a floor to support sliding plate assembly 160 at the bottom. As such, sliding plate 160 will be loosely held in place by cross bar 172 at the top and partial bottom wall 116 at the bottom, but not so closely held as to inhibit its ability to slide forward and backward when it is pulled out or pushed in.

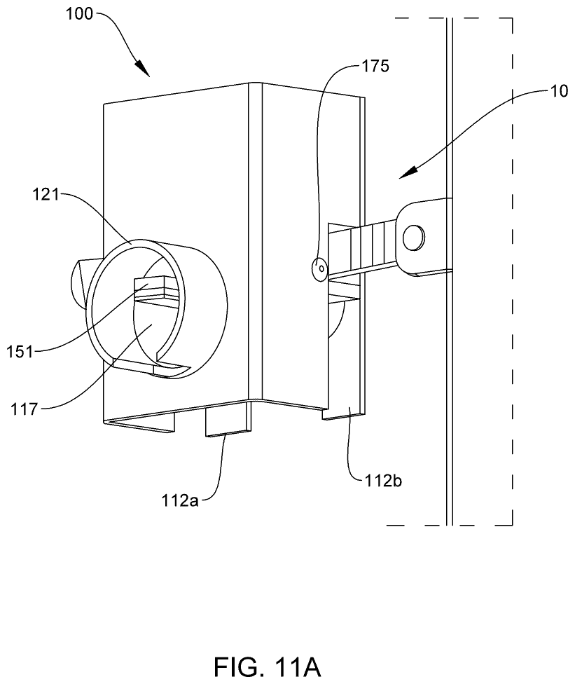

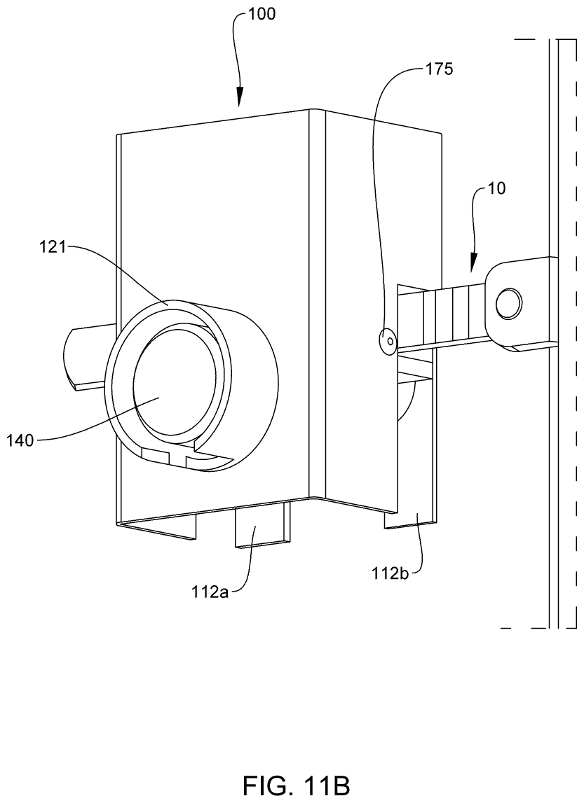

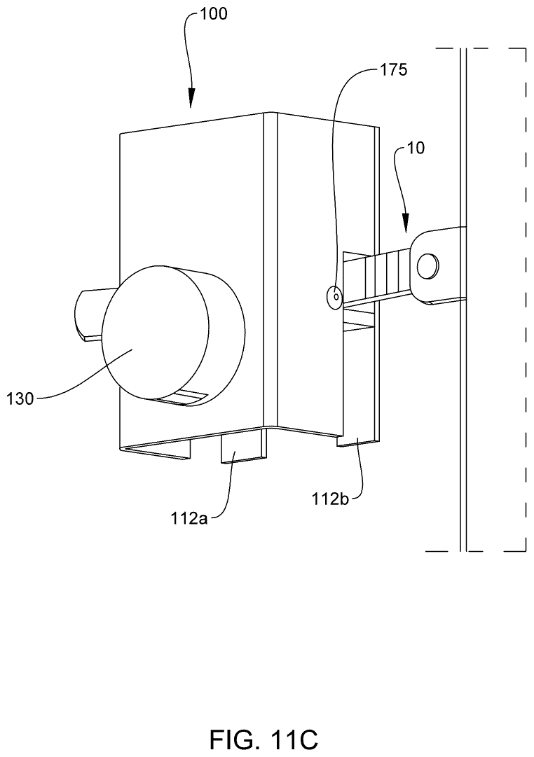

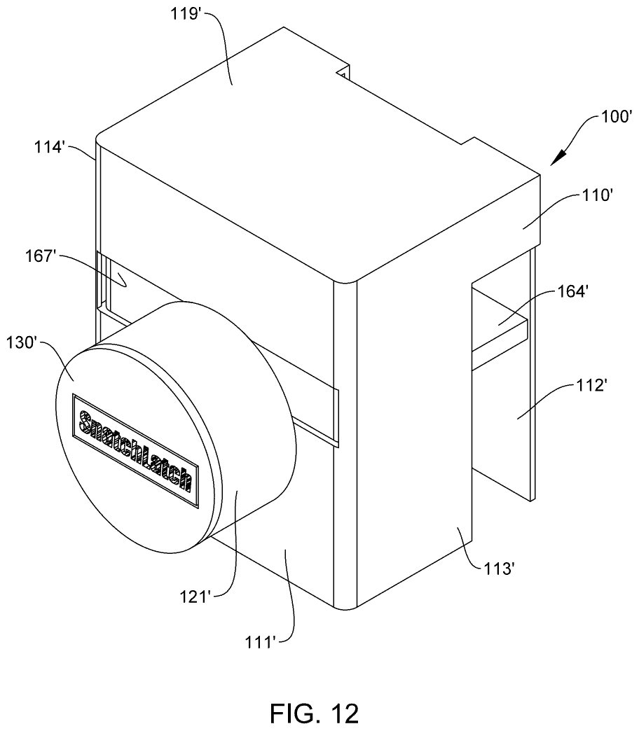

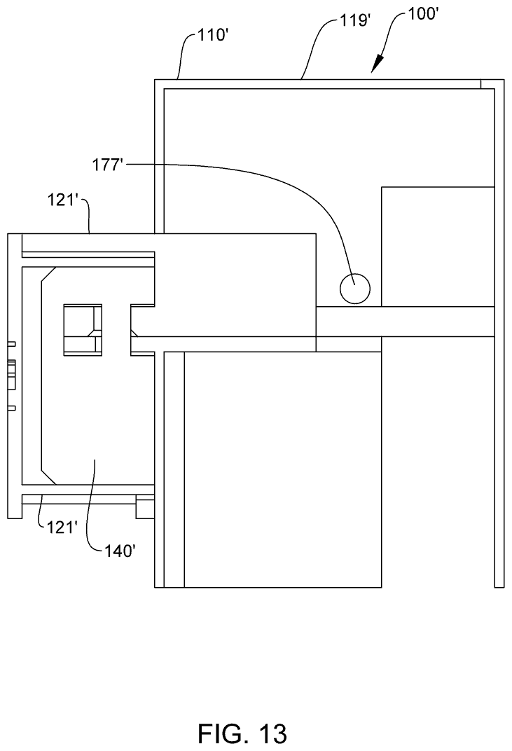

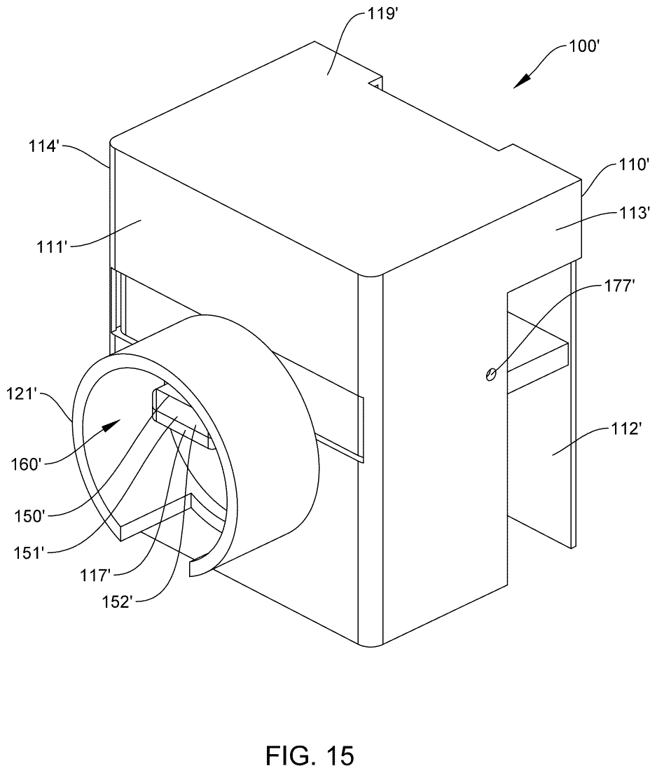

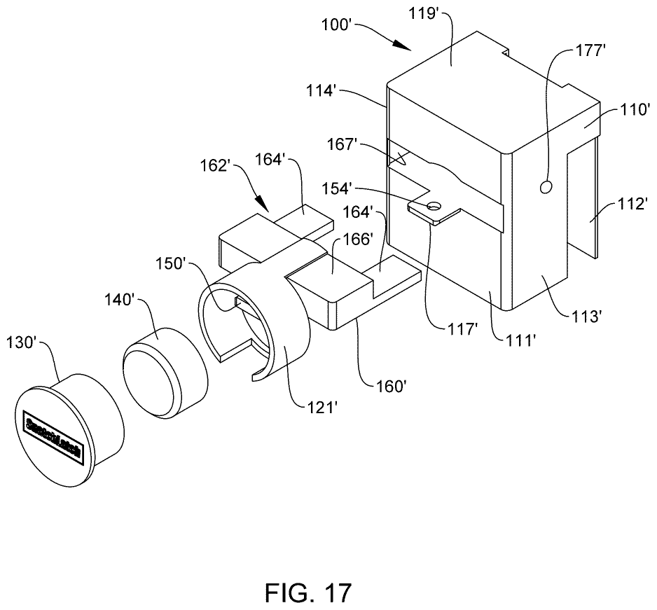

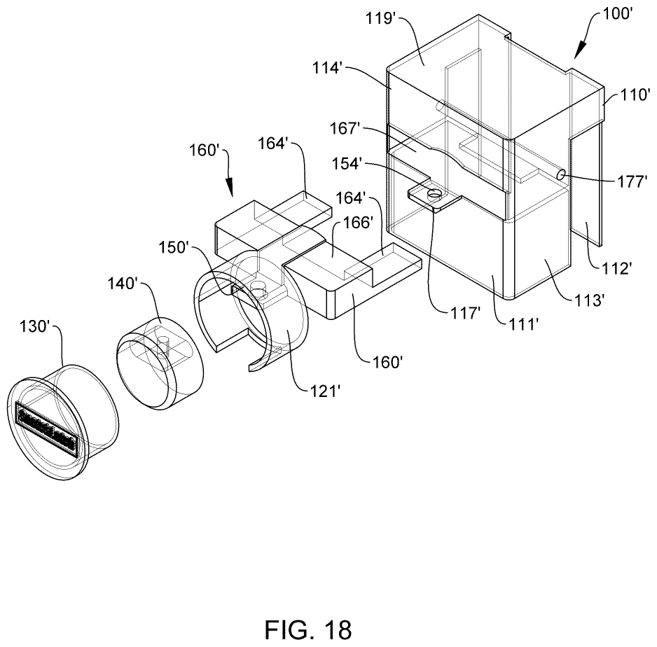

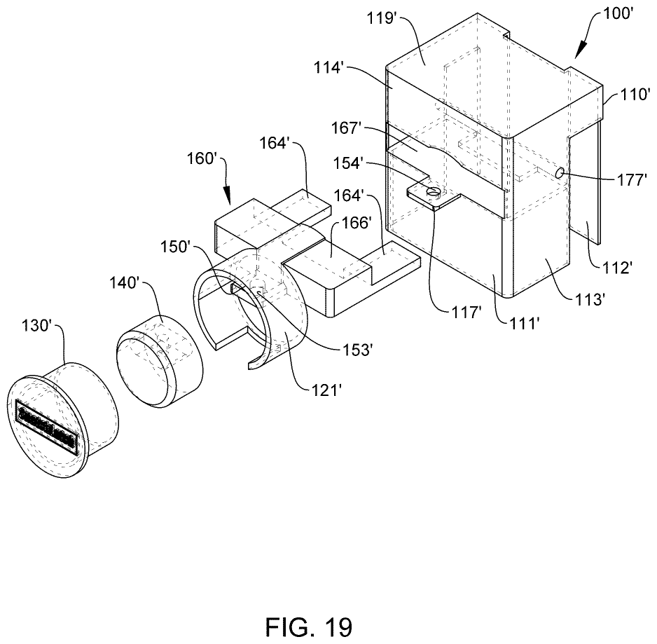

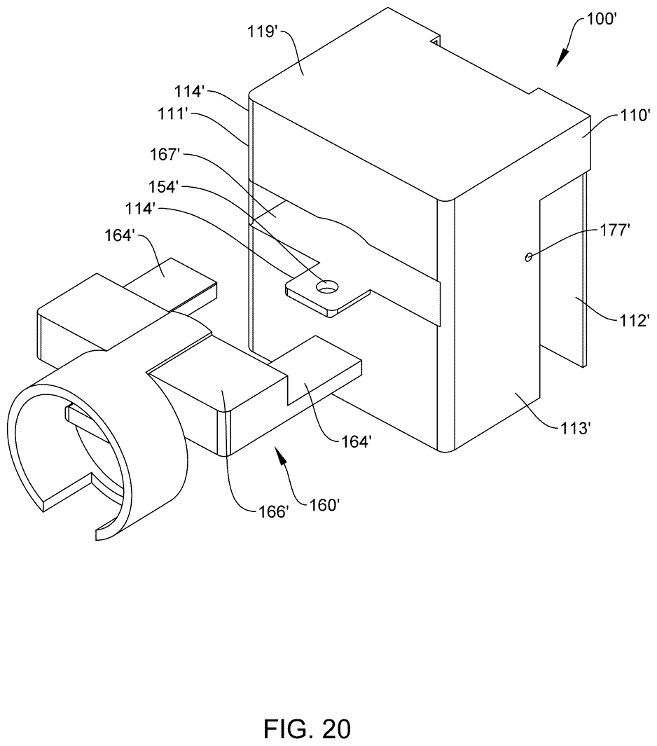

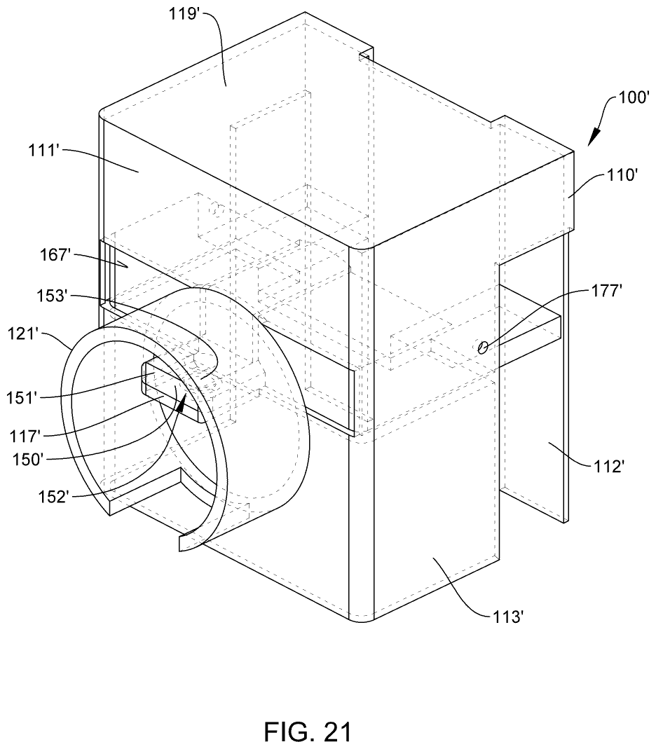

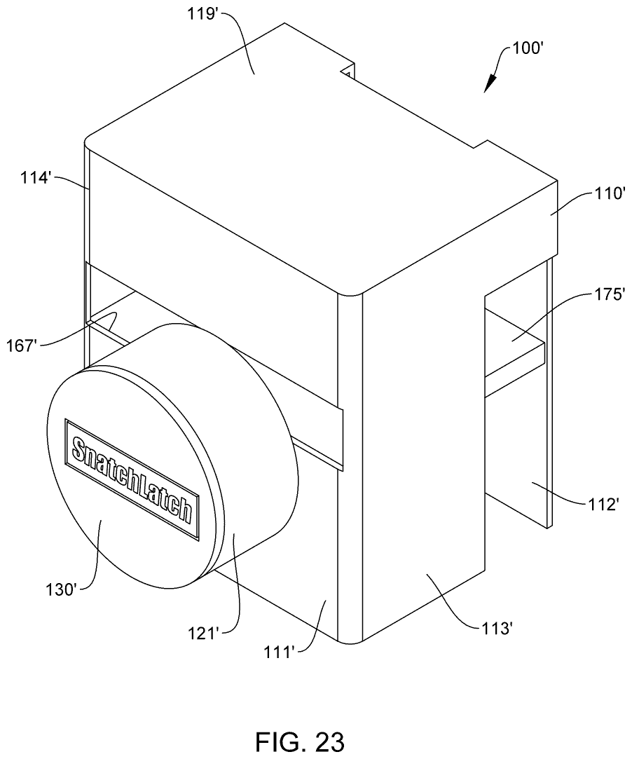

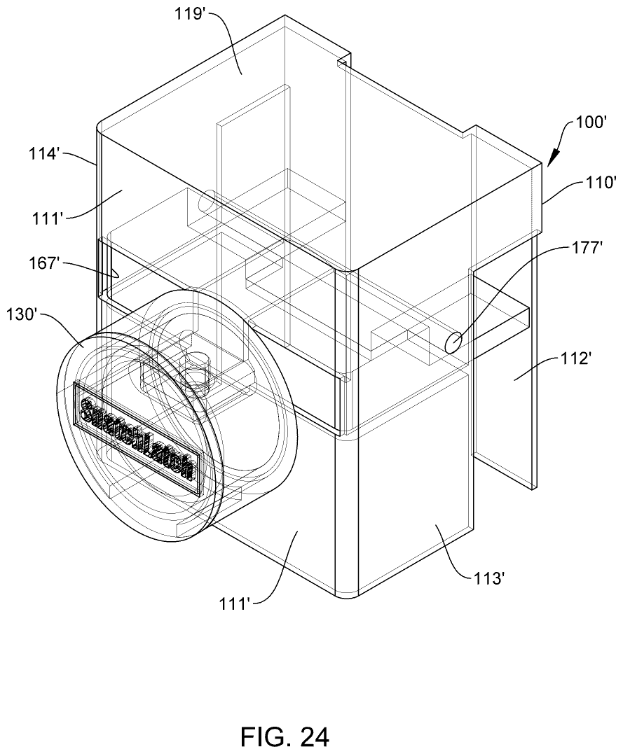

FIGS. 9-17, and 19-24 illustrate another embodiment of a modified device 100′, which includes a modified sliding assembly 160′ as part of the modified device 100′. Sliding assembly 160′ is similar to sliding assembly 160, except that it also includes a tubular wall 121′, which is securely attached to the sliding assembly 160′ such that it forms an integral part thereof. Tubular wall 121′ can be welded to the other parts of modified sliding assembly 160′, cast, forged or manufactured with the other parts of sliding assembly in any other manner such that all parts are held together securely.

Once the modified sliding assembly 160′ is in this position, rivets 175 are secured on each side 113′ and 114′ of the housing 110′ to capture the sliding assembly 160′ within the housing 110′ so the sliding assembly 160′ cannot fall out of the housing 110′ when the housing 110′ is being handled before and during installation onto the door handle, regardless of the position of the housing 110′, but is free to move in and out a limited distance to permit locking and unlocking when the housing 110′ and sliding assembly 160′ are installed onto the door. However, in this embodiment the sliding assembly 160′ will be removed entirely out of the front slot of the housing 110′ when the device 100′ is unlocked. Thus, cross bar 172 is not necessary to hold the sliding assembly 160′ in place when the device 100′ is unlocked, since it will be removed (for unlocking) and replace (for locking) during normal use anyway.

FIGS. 10, 12, 17 and 19-21 illustrate the device 100′ in exploded view showing, in isometric view, modified sliding assembly 160′ to the left of a modified housing 110′ (shown right side up) to the right of modified sliding assembly 160′. To assemble these parts, modified sliding assembly 160′ would be inserted into the opening 167′ in the modified front wall 111′ of modified housing 110′. In ordinary usage, with modified housing 110′ in an upright orientation, as illustrated, the fork end of modified sliding assembly 160′ would be inserted up into the front opening 167′ of modified housing 110′ such that the modified first end 151′ of the modified pull tab 152′ of modified sliding plate assembly 160′ would extend outside the front opening 167′, as illustrated in cross-section in FIG. 9, for example, once the modified sliding assembly 160′ is place.

Modified housing 110′ is open at its bottom end and has slots in the lower portion of its side walls 113′ and 114′ near the rear end of the housing 110′ to allow it to be installed onto the door handle. Housing 110′ also includes an internal, horizontal middle floor 179, which can be affixed by welding or other secure means to the inside of front wall 111 and the inside portion of side walls 113′ and 114′ of modified housing 110', forward of the side slots. Middle floor 179 includes a modified housing tab 117′ portion extending forwardly through the opening 167′ in front wall 111′ of modified housing 110′. Modified housing tab 117′ includes a hole for receiving the tumbler 142 of lock 140 that can extend through both the hole in tab 117 and the hole in the front end 151 of modified slide handle 150, to secure modified housing 110′ onto the door when the lock 140 is locked.

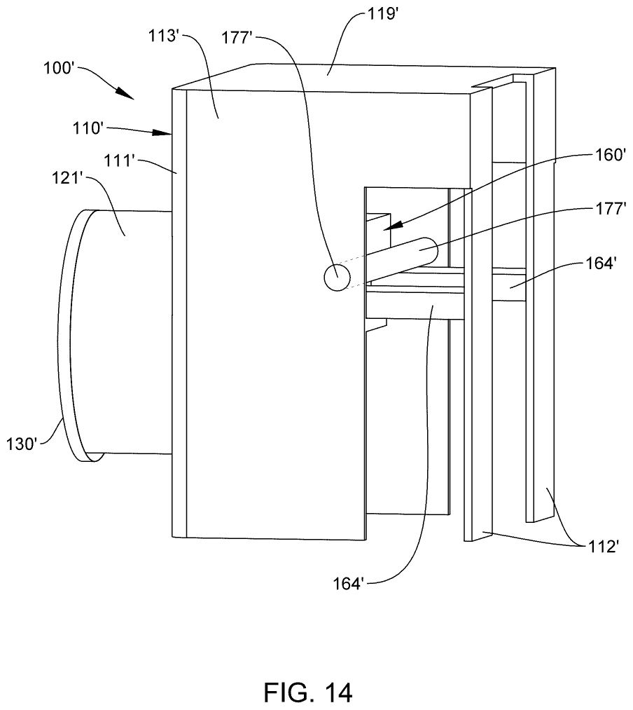

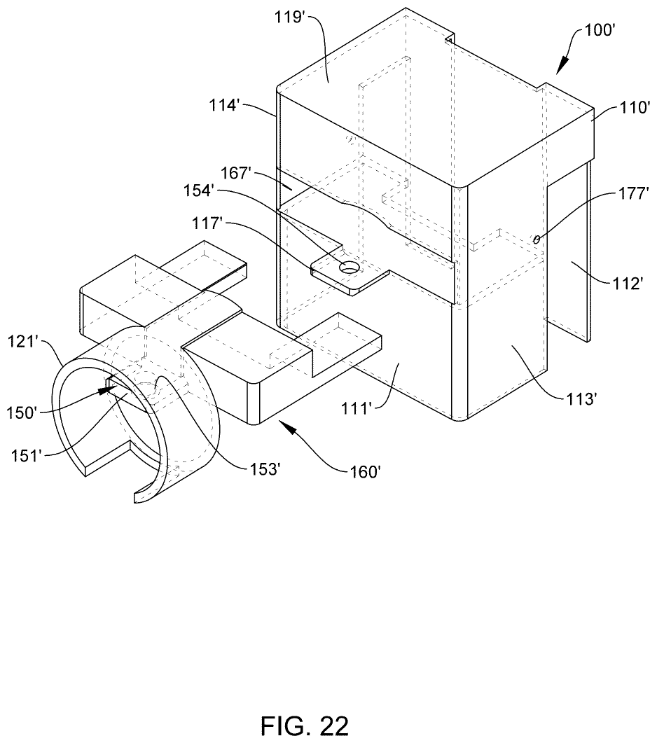

The embodiment of the invention employing modified housing 110′ and modified sliding assembly 160′ can, optionally, employ a means to retain modified sliding assembly 160′ inside the opening 167′ in modified housing 110′, even when the modified device 100′ is not installed on the door handle. For this purposes, the means can employ, for example, rivets 175 on the sides of modified housing 110′, similar to how rivets 175 are used in the context of unmodified housing 110, or a side-to-side through-rod 177′, as illustrated in FIGS. 14 and 22, for example, to retain the sliding assembly 160′ at least loosely in place, even when the device 100 is not locked in place. In this embodiment, the ends of the inwardly extending fork tines or legs 164′ of modified sliding assembly 160′ can have upwardly raised edges on the upper ends thereof to “catch” the rivets 175. Or, a through-rod 177 can be inserted from the outside of the modified housing 110′, through holes provided in each side 113′ and 114′ of the housing, to hold at least part of modified sliding assembly 160′ at least loosely in place in the housing 110′ when housing 110′ is no locked into place. Through-rod 177 can then be secured to the sides 113′ sand 114′ by welding, use of an interference fit, threading of at least one end into the side of the modified housing 110′, or any convenient means.

In this embodiment, the rivets 175 or through-rod 177 is/are not required to prevent unauthorized access to the door handle once the modified device 100′ is fully installed and locked onto the door; that function is accomplished by locking the tumbler 142 on the lock 140 securing the entire device 100′ in place on the door. That is, when the assembly is locked onto the door (by an unauthorized person drilling out the rivets 175 or rod 177, the modified device 100′ will remain fully locked in place. Alternatively, the rivets 175 and/or through-rod 177 can be omitted entirely, in which case, the sliding assembly 160′ can be fully removable by hand (when unlocked) and stored independently from modified housing 110′.

Although the present disclosure and its advantages have been described in detail, it should be understood that various changes, substitutions and alterations can be made herein without departing from the spirit and scope of the disclosure as defined by the appended. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A device for securing a door lock and handle, the device comprising:
a housing having a front wall and side walls, at least one of the side walls defining a slot configured to receive the door lock and handle and at least partially enclose the door lock and handle;
a locking portion extending outwardly from the housing, the locking portion configured to receive a lock therewithin;
a sliding plate configured to selectively cover or engage the door lock and handle, wherein the sliding plate is movable between a pulled position exposing the door lock and handle, and a pushed position, wherein the sliding plate is configured to be engaged with the lock and be locked thereby when the lock is received within the locking portion, so as to restrict the movement of the sliding plate towards the pulled position.

2. The device of claim 1, wherein the slot includes an open end to allow the door lock and handle to be received in the slot, and a closed end configured to rest over the door lock and handle, thereby engaging the housing with the door lock and handle.

3. The device of claim 2, wherein when the closed end rests over the door lock and handle, the closed end engages the door lock and handle from an upper side of the door lock and handle.

4. The device of claim 2, wherein the housing comprises a back wall configured to be received behind the door lock and handle.

5. The device of claim 4, comprising a cap configured to be disposed between a covering position and an uncovering position, wherein in the covering position, the cap is configured to be locked in place covering the majority of the lock to prevent access to the lock when the lock is received within the locking portion.

6. The device of claim 1, wherein when the housing covers the door lock and handle, and when the sliding plate is in the pushed position, the device is in a locked state thereof, in which a movement of the device with respect to the door lock and handle is restricted.

7. The device of claim 1, wherein when the housing covers the door lock and handle, and when the sliding plate is in the pulled position, the device is in an unlocked state thereof, in which a movement of the device with respect to the door lock and handle is allowed.

8. The device of claim 1, wherein the sliding plate in the pushed position is disposed under the door lock and handle, so as to cover or engage the door lock and handle from a lower side of the door lock and handle.

9. The device of claim 1, wherein the sliding plate comprises a plate pull tab disposed at a first end thereof, wherein the plate pull tab is configured to be received within a groove of the lock, the plate pull tab comprising a plate aperture configured to receive a locking pin of the lock.

10. The device of claim 9, wherein the housing further comprises a housing tab, wherein the plate pull tab is aligned with the housing tab at least when the sliding plate is in the pushed position, and wherein the housing tab is configured to be engaged with the lock along with the first pull tab.

11. The device of claim 1, wherein the sliding plate comprises at least one locking tab at a second end thereof, wherein in the pushed position the at least one locking tab covers the door lock and handle from a lower side.

12. The device of claim 11, wherein in the pulled position of the sliding plate, the locking tab enables a movement of the housing with respect to the door lock and handle, so as to allow a free movement of the door lock and handle within the slot.

13. The device of claim 1, wherein the locking portion extends outwardly from the front wall of the housing.

14. The device of claim 5, wherein the locking portion comprises a gap configured to allow access to the lock through the locking portion, wherein the cap in the covering position is configured to cover at least the gap of the locking portion, thereby preventing access to the lock through the gap of the locking portion.

15. The device of claim 1, wherein in the covering position, the cap is configured to be at least partially received within the locking member, and wherein in the uncovering position, the lock is accessible through one or more of the lock receiving opening and the gap of the locking portion.

16. The device of claim 15, wherein the cap comprises a first covering member configured to cover the gap and a second covering member configured to cover the lock receiving opening, when the cap is in the covering position.

17. The device of claim 16, wherein the locking portion comprises a lock receiving opening for receiving the lock within the locking portion via the lock receiving opening, and wherein the cap is configured to cover the lock receiving opening in the covering position thereof so as to prevent access to the lock via the lock receiving opening.

18. The device of claim 16, wherein the locking portion is a tubular member comprising a tubular wall, wherein the gap is formed in the tubular wall of the tubular member, the gap defining an access passage through the tubular wall, and wherein when the lock is received within the locking portion and the cap is in the covering position, the tubular wall and the cap substantially fully enclose the lock with the exception of sufficient access to insert a key associated with the lock.
